(19) United States
(12) Patent Application Publication
(10) Pub. No.: US 2023/0189179 A1
(43) Pub. Date: Jun. 15, 2023

(54) Methods for reporting timing advance in Non-Terrestrial Network communications and communication apparatus utilizing the same

(71) Applicant: MediaTek Singapore Pte. Ltd., Singapore (SG)

(72) Inventors: Mehmet Kunt, Cambridge (GB); Abdelkader Medles, Cambridge (GB); Gilles Charbit, Cambridge (GB)

(73) Assignee: MediaTek Singapore Pte. Ltd., Singapore (SG)

(21) Appl. No.: 17/924,688

(22) PCT Filed: May 6, 2021
(86) PCT No.: PCT/SG2021/050251

§ 371 Date: Nov. 11, 2022

Related U.S. Application Data
(60) Provisional application No. 63/022,625, filed on May 11, 2020.

(51) Int. Cl. H04W 56/00; H04W 74/08

(52) U.S. Cl. CPC H04W 56/004; H04W 74/0833; H04W 84/06

(57) ABSTRACT

A communication apparatus includes a transceiver and a processor. The transceiver is configured to transmit and receive wireless signal. The processor is coupled to the transceiver and configured to perform operations comprising: establishing, via the transceiver, a wireless connection with a network node of a non-terrestrial network (NTN); and transmitting, via the transceiver, a timing advance (TA) report to the network node. The processor is configured to perform auto-compensation of time delays in signaling and a TA value is indicated in the TA report.

### CROSS REFERENCE TO RELATED APPLICATION

This application claims the benefit of U.S. Provisional Application No. 63/022,625 filed 2020 May 11, the entirety of which is incorporated by reference herein.

### BACKGROUND OF THE INVENTION

### 1. Field of the Invention

The disclosure is generally related to mobile communications and, more particularly, to User Equipment (UE) Timing Advance (TA) reporting in Non-Terrestrial Network (NTN) communications.

### 2. Description of the Prior Art

Unless otherwise indicated herein, approaches described in this section are not prior art to the claims listed below and are not admitted as prior art by inclusion in this section.

In wireless communications such as mobile communications under 3^{rd} Generation Partnership Project (3GPP) specifications, timing advance corresponds to the duration of time it takes a signal to reach a base station (e.g., gNB) from a UE. In non-terrestrial network (NTN) systems in which a NTN node, such as a satellite, is hundreds of kilometers above the surface of the Earth, timing advance can be very large.

For UEs with auto-compensation capability of the delay spread with the assistance of Global Navigation Satellite System (GNSS) or other means, the base station would not be aware of the TA. For frequency division duplexing (FDD)-half-duplex systems and time division duplexing (TDD), downlink (DL) and uplink (UL) scheduling by the base station could collide on the UE's side unless the base station is aware of the TA used by the UE.

In order to avoid misalignment in timing, there is a need for a solution that enables the UE to report its TA to the base station in NTN communications.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure pertain to TA reporting by UE in NTN communications.

In one aspect accordance with an implementation of the present disclosure, a communication apparatus comprises a transceiver and a processor. The transceiver is configured to transmit and receive wireless signal. The processor is coupled to the transceiver and configured to perform operations comprising: establishing, via the transceiver, a wireless connection with a network node of a non-terrestrial network (NTN); and transmitting, via the transceiver, a timing advance (TA) report to the network node. The processor is configured to perform auto-compensation of time delays in signaling and a TA value is indicated in the TA report.

In accordance with another implementation of the present disclosure, a method for reporting timing advance (TA) comprises: establishing, by a processor of a communication apparatus capable of auto-compensation of time delays in signaling, a wireless connection with a network node of a wireless network; and transmitting, by the processor, a TA report to the network node. A TA value is indicated in the TA report, and triggering of transmitting the TA report is initiated either at the network node or at the communication apparatus.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIoT) and non-terrestrial network (NTN), the proposed concepts, schemes and any variation(s)/derivative(s) thereof may be implemented in, for and by other types of radio access technologies, networks and network topologies. Thus, the scope of the present disclosure is not limited to the examples described herein.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an example network environment in which various proposed schemes in accordance with the present disclosure may be implemented.

FIG. 2 illustrates an example communication apparatus and an example network apparatus in accordance with an implementation of the present disclosure.

FIG. 3 illustrates an example hysteresis-based mechanism based on actual TA value in accordance with an implementation of the present disclosure.

FIG. 4 illustrates an example hysteresis-based mechanism based on quantized TA value KI in accordance with an implementation of the present disclosure.

FIG. 5 illustrates an example TA Report MAC CE in accordance with an implementation of the present disclosure.

FIG. 6 illustrates an example message flow for TA Report in 4-step RACH in accordance with an implementation of the present disclosure.

FIG. 7 illustrates another example message flow for TA Report in 4-step RACH in accordance with an implementation of the present disclosure.

FIG. 8 illustrates yet another example message flow for TA Report in 4-step RACH in accordance with an implementation of the present disclosure.

FIG. 9 illustrates an example message flow for TA Report in 2-step RACH in accordance with an implementation of the present disclosure.

FIG. 10 illustrates an example message flow for TA Report via a new IE in existing RRC message in accordance with an implementation of the present disclosure.

FIG. 11 illustrates an example message flow for TA Report via a new RRC message in accordance with an implementation of the present disclosure.

FIG. 12 illustrates an example message flow for TA Report when there are no UL resources available in accordance with an implementation of the present disclosure.

FIG. 13 illustrates an example process of a method for reporting timing advance in NTN communications in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The disclosure may, however, be embodied in many different forms and should not be construed as limited to the exemplary embodiments and implementations set forth herein. Rather, these exemplary embodiments and implementations are provided so that description of the disclosure is thorough and complete and will fully convey the scope of the disclosure to those skilled in the art. In the description below, details of well-known features and techniques may be omitted to avoid unnecessarily obscuring the presented embodiments and implementations.

### Overview

Implementations in accordance with the disclosure relate to various techniques, methods, schemes and/or solutions pertaining to TA reporting by UE in NTN communications. According to the disclosure, a number of possible solutions may be implemented separately or jointly. That is, although these possible solutions may be described below separately, two or more of these possible solutions may be implemented in one combination or another.

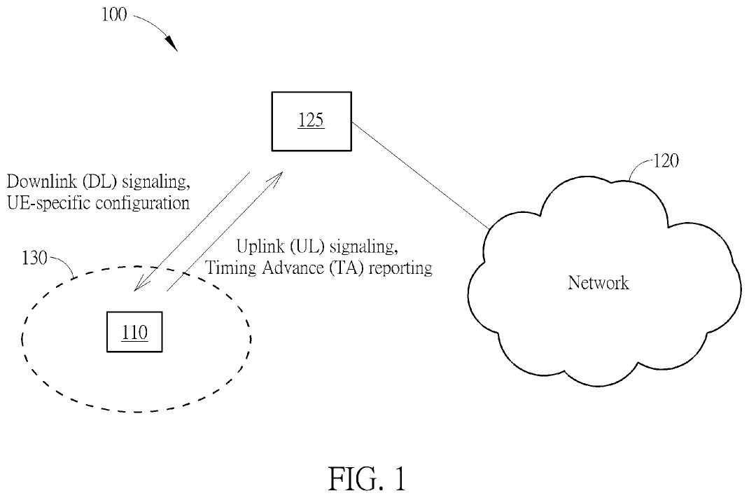

FIG. 1 illustrates an example network environment 100 in which various proposed schemes in accordance with the present disclosure may be implemented. Network environment 100 may involve a UE 110 and a wireless network 120 (e.g., an LTE network, a 5G network, a NR network, an IoT network, an NB-IoT network, an IIoT network, an NTN network or any combination thereof). UE 110 may communicate with wireless network 120 via a network node 125. In some cases, network node 125 may be a non-terrestrial (NT) network node (e.g., a satellite) of an NTN. For these cases, the network node 125 may further communicate with a terrestrial network node (e.g., a base station (BS) such as a gNB, eNB or transmission/reception point (TRP)) in the wireless network 120, for relaying the wireless signals received from the UE 110 to the terrestrial network node or relaying the wireless signals received from the terrestrial network node to the UE 110. In some cases, network node 125 may be a terrestrial network node (e.g., a base station (BS) such as a gNB, eNB or transmission/reception point (TRP)). Each of UE 110 and network node 125 may be configured to perform operations pertaining to TA reporting by UE 110 under various proposed schemes in accordance with the present disclosure, as described below.

Under a proposed scheme in accordance with the present disclosure, to allow network node 125 to schedule UE 110 without collision between DL transmission(s) and UL transmission(s), UE 110, which is capable of auto-compensation of time delays in signaling, may report its TA to network node 125. UE 110 may provide a TA report which indicates a TA value to network node 125. For instance, UE 110 may provide a TA report by transmitting the TA report in a medium access control (MAC) control element (CE). Alternatively, or additionally, UE 110 may provide a TA report to network node 125 through UL control information (e.g., in physical uplink control channel (PUCCH) transmission). Alternatively, or additionally, UE 110 may provide a TA report to network node 125 through higher-layer signaling (e.g., via radio resource control (RRC) signaling).

Under a proposed scheme in accordance with the present disclosure, TA reporting may be transmitted as part of a random access channel (RACH) procedure (or, named as random access (RA) procedure). For instance, once UE 110 detects network 120 as an NTN and network node 125 as a satellite, UE 110 may transmit a TA report to network node 125 in a RACH procedure (e.g., in message 3 (Msg3), message 5 (Msg5) or message A (MsgA) in a 2-step or 4-step RACH procedure). Moreover, under the proposed scheme, UE 110 may be configured to autonomously transmit its TA report to network node 125 periodically or non-periodically. Alternatively, TA reporting by UE 110 may be trigger-based or request-based (e.g., based on a trigger signal or a request from network node 125) or in accordance with a UE protocol. As an example, UE 110 may be configured to transmit a TA report to network node 125 in response to a value of TA deviating from a threshold by at least a predefined amount. As another example, UE 110 may be configured to transmit a TA report to network node 125 according to a timer (e.g., upon expiry of the timer which may be reset to start countdown again upon expiry). As another example, UE 110 may be configured to transmit a TA report to network node 125 in response to a TA report request received from network node 125.

Under a proposed scheme in accordance with the present disclosure, TA reports received by network node 125 from UE 110 may be used by network node 125 to configure an offset value (K_{offset}) specific to UE 110. The K_{offset} may be utilized to extend K1 and/or K2. K1 is the offset between a DL slot where data is scheduled on a physical downlink shared channel (PDSCH) and an UL slot where an acknowledgement/negative acknowledgement (ACK/NACK) feedback for the scheduled PDSCH data is to be sent. K2 is the offset between a DL slot where a physical downlink control channel (PDCCH) (e.g., downlink control information (DCI)) for UL scheduling is received by UE 110 and an UL slot where UL data is to be sent on a physical uplink shared channel (PUSCH). Under the proposed scheme, network node 125 may configure the K_{offset} specific to UE 110 based on TA report(s) received from UE 110 to extend value ranges of K1 and/or K2. Under the proposed scheme, upon configuring the UE-specific K_{offset}, network node 125 may transmit the K_{offset} to UE 110 for UL scheduling and other procedures. Under the proposed scheme, the K_{offset} may be initially based on a maximum roundtrip time (RTT) over a beam (e.g., cell 130) the coverage area of which UE 110 is located. Once UE 110 has established a wireless connection with network node 125, network node 125 may transmit the UE-specific K_{offset}, which may be configured based on a TA value indicated in the TA report(s), to UE 110.

### Illustrative Implementations

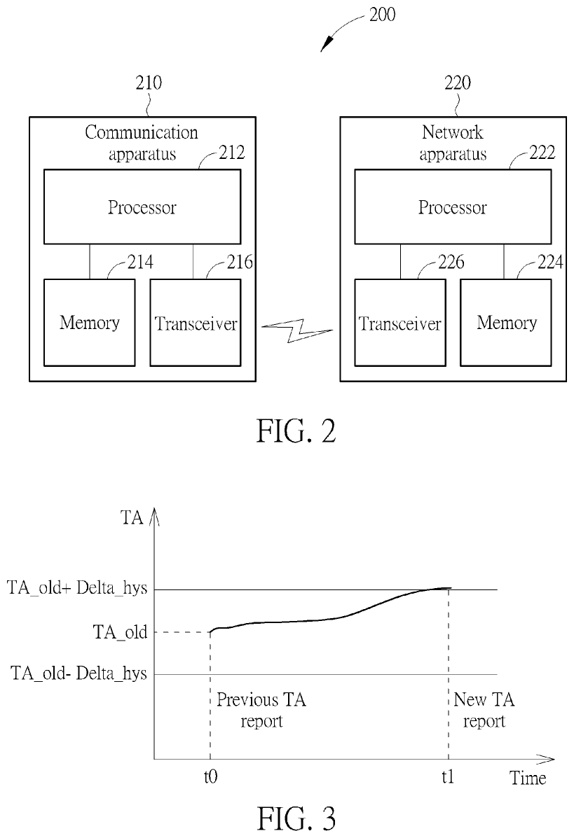

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to TA reporting by UE in NTN communications, including scenarios/schemes described above as well as the process described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smart watch, a personal digital assistant, a digital camera, or a computing equipment such as a tablet computer, a laptop computer or a notebook computer. Communication apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNB in an LTE, in a gNB in a 5G, NR, IoT, NB-IoT, IIoT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction, timing misalignment avoidance, . . . etc. in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and configured to transmit and receive wireless signals. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and configured to transmit and receive wireless signals. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., network node 125) of a communication network (e.g., network 120). It is also noteworthy that, although the example implementations described below are provided in the context of NTN, the same may be implemented in other types of networks.

Under a proposed scheme pertaining to TA reporting by UE in NTN communications in accordance with the present disclosure, with communication apparatus 210 implemented in or as UE 110 and network apparatus 220 implemented in or as network node 125 in network environment 100, communication apparatus 210 may be capable of auto-compensation of time delays in signaling, for example, with the assistance of GNSS or other means. Processor 212 may establish, via transceiver 216, a wireless connection with network apparatus 220 as a network node (e.g., network node 125) of a wireless network (e.g., network 120). Processor 212 may transmit, via transceiver 216, a TA report to network apparatus 220.

### TA Report

In some implementations of the present disclosure, the TA report reported by UE may comprise a TA value, which may be an actual TA value computed or measured by processor 212 or an index KI of a quantized TA value.

To be more specific, in some embodiments of the present disclosure, the TA value may be quantized by processor 212 by using a quantization step Δ. The quantization step Δ may be defined in second, for example Δ=0.1 us. Alternatively, or additionally, the quantization step Δ may be defined with respect to sampling time Ts as Δ=k*Ts or the chip time Tc as Δ=k*Tc, where k is an integer number. The sampling time Ts and the chip time Tc may be pre-configured values and/or may be defined in the 3GPP specification. Alternatively, or additionally, the quantization step A may be either a constant that is defined in the specification or signaled to the UE.

In some embodiments of the present disclosure, the TA report may correspond to: reported_TA=t0+KI*A, where t0 may be a common configured bias that may correspond for example to the beam common TA, and the index KI may be an integer number that is sent in the TA report. In one embodiment, the index KI may be restricted to be either negative or positive. In another embodiment, the index KI may be unrestricted taking positive and negative value.

In some embodiments of the present disclosure, the index KI may be calculated from the actual TA value used by the UE as: floor ((TA−t0)/Δ), where the floor operation may be replaced by ceiling or round operation, and other variations of the quantization formula may also possible. The exemplary operations are not intended to be limiting in any way.

### Triggers for the TA Report

Triggering of transmitting the TA report may be initiated either at the network node or at the communication apparatus.

In some implementations, the triggers for the TA report is initiated by network node 125 (e.g. the network apparatus 220).

There may be a plurality of network initiated report options, comprising: with PDCCH order, by paging the UE, by sending MAC CE to the UE to request a report, and by sending an RRC message to the UE to request a report, wherein one or more may be applied in the implementations of the present disclosure.

In some embodiments of the present disclosure, when network node 125 initiates contention based random access with PDCCH order (e.g. signaled preamble index=000000), UE may be aware of that reporting of TA is triggered and processor 212 may be configured to perform the operation of transmitting the TA report responsive to the PDCCH order signaling received from network node 125.

In some embodiments of the present disclosure, responsive to the contention based random access with PDCCH order initiated by network node 125, processor 212 may transmit the TA report in message 3 (Msg3), message 5 (Msg5) or message A (MsgA) in a 2-step or 4-step RACH procedure.

In some embodiments of the present disclosure, when network node 125 initiates contention free random access with PDCCH order (e.g. signaled preamble index !=000000), UE may be aware of that reporting of TA is triggered and processor 212 may be configured to perform the operation of transmitting the TA report responsive to the PDCCH order signaling received from network node 125.

In some embodiments of the present disclosure, responsive to the contention free random access with PDCCH order initiated by network node 125, processor 212 may transmit the TA report using the UL grant in a message 2 (Msg2).

In some embodiments of the present disclosure, a new field may be introduced or added in the Paging message to indicate a TA report request and processor 212 may be configured to perform the operation of transmitting the TA report responsive to the Paging message received from the network node. Responsive to the Paging message with a field indicating a TA report request from network node 125, processor 212 may trigger a RA procedure and transmit the TA report in message 3 (Msg3), message 5 (Msg5) or message A (MsgA).

In some embodiments of the present disclosure, when the UE is in Connected mode, network node 125 may send a MAC CE for TA report request and the UE may respond with a MAC CE with TA report. For example, processor 212 may be configured to perform the operation of transmitting the TA report responsive to a TA report request received from network node 125 in an MAC CE.

In some embodiments of the present disclosure, when the UE is in Connected mode, network node 125 may send an RRC message to request a report and the UE may send an RRC message as response. For example, processor 212 may be configured to perform the operation of transmitting the TA report responsive to a TA report request received from network node 125 via an RRC message or RRC signaling.

In some implementations, the triggers for the TA report is initiated by the UE 110 (e.g. the communication apparatus 210).

There may also be a plurality of UE initiated report options, comprising: hysteresis-based or threshold-based, timer-based and procedure-based, wherein one or more may be applied in the implementations of the present disclosure.

In some embodiments of the present disclosure, the hysteresis may be based directly on the TA being used by the UE or a quantized version of the TA (i.e. the aforementioned KI). The processor 212 may monitor the TA/KI value and when the TA/KI value is outside a hysteresis range, or when the TA/KI value is greater than or lower than a predetermined threshold, or when the TA/KI value is deviating from a threshold by at least a predefined amount, the UE 110 may initiate the TA report. For example, processor 212 may be configured to perform the operation of transmitting the TA report responsive to a TA value deviating from a threshold by at least a predefined amount.

FIG. 3 illustrates an example hysteresis-based mechanism based on actual TA value in accordance with an implementation of the present disclosure. In some embodiments of the present disclosure, at time t1, if the current TA value (that is, the actual TA value currently obtained by the computing or measuring) deviates from the previous TA value: TA_old, reported at time t0, by at least a predefined amount, such as TA>=TA_old+Delta_hys or TA<=TA_old-Delta_hyss, then UE sends a new TA report, where Delta_hys is a Delta hysteresis. The Delta hysteresis value may be fixed in the specifications or pre-configured.

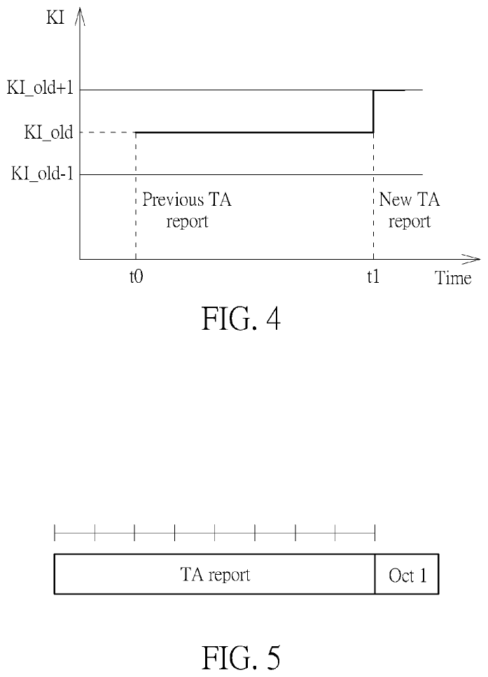

FIG. 4 illustrates an example hysteresis-based mechanism based on quantized TA value KI in accordance with an implementation of the present disclosure. In this example, the Delta hysteresis may also be specified in quantized value as the TA value. In some embodiments of the present disclosure, at time t1, if the current KI value deviates from the previous KI value: KI_old, reported at time t0, by at least a predefined amount, such as KI>=KI_old+Delta_hys or KI<=KI_old-Delta_hys, then UE sends a new TA report. Here, the Delta_hys is set to 1.

In some embodiments of the present disclosure, when a predetermined timer expires, the UE 110 may initiate the TA report. In the timer-based approach, the UE 110 may transmit its TA report to network node 125, periodically or non-periodically, responsive to expiry of a timer.

In some embodiments of the present disclosure, the UE 110 may always report the TA during the RA procedure, even if the RA procedure has been initiated because of another event (e.g. initial access from RRC Idle, RRC connection re-establishment, handover, DL/UL data arrival when “non-synchronised”, or for positioning). For example, processor 212 may be configured to perform the operation of transmitting the TA report autonomously in a predetermined procedure, such as the aforementioned RA procedure.

In some embodiments of the present disclosure, the UE 110 may report the TA for certain RA procedure, for example, for a subset of: Initial access from RRC Idle, RRC connection re-establishment, handover, or DL/UL arrival when “non-synchronised” and positioning.

In some implementations, in transmitting the TA report, processor 212 may transmit the TA report responsive to determining that network apparatus 220 is a satellite of an NTN.

In some implementations, in transmitting the TA report, processor 212 may transmit the TA report responsive to determining that TA has not been reported before (e.g. it is an initial access to the wireless network).

### Reporting TA to the Network

In some implementations, in transmitting the TA report, processor 212 may transmit the TA report in an MAC CE.

In some embodiments of the present disclosure, a new MAC CE may be introduced (e.g. TA Report MAC CE), and may use a currently unused (reserved) logical channel identifier (LCID) value.

FIG. 5 illustrates an example TA Report MAC CE in accordance with an implementation of the present disclosure. The TA information (e.g. the “TA report” in FIG. 5) may consist of 8 bits.

In some embodiments of the present disclosure, the priority of the TA Report MAC CE may be, as an example, lower than: cell-radio network temporary identifier (C-RNTI) MAC CE or data from UL-Common Control Channel (CCCH); and/or higher than: data from any Logical Channel, except data from UL-CCCH. As an option, the priority of the TA Report MAC CE may be higher than any other MAC CE (except C-RNTI MAC CE), so that the TA Report MAC CE may be prioritized in order to establish a reliable connection with the network.

In some implementations, in transmitting the TA report, processor 212 may transmit the TA report in UL control information.

In some implementations, in transmitting the TA report, processor 212 may transmit the TA report via higher-layer signaling (e.g., RRC signaling).

In some embodiments of the present disclosure, the TA may be reported in a new RRC message, such as RRCTimingAdvanceReport.

In some embodiments of the present disclosure, the TA may be reported in a new information element (IE) in existing RRC message(s). As an example, the new IE may be added in the following RRC messages in italic type:

For LTE/NB-IoT:

MeasurementReport

RRCConnectionReconfigurationComplete/RRCConnectionReconfigurationComplete-NB

RRCConnectionReestablishmentComplete/RRCConnectionReestablishmentComplete-NB

RRCConnectionReestablishmentRequest/RCConnectionReestablishmentRequest-NB

RRCConnectionRequest/RRCConnectionRequest-NB

RRCConnectionResumeComplete/RRCConnectionResumeComplete-NB

RRCConnectionResumeRequest/RRCConnectionResumeRequest-NB

RRCConnectionSetupComplete/RRCConnectionSetupComplete-NB

RRCEarlyDataRequest/RRCEarlyDataRequest-NB

ULInformationTransfer/ULInformationTransfer-NB

For NR:

MeasurementReport

RRCReestablishmentComplete

RRCReestablishmentRequest

RRCReconfigurationComplete

RRCResumeComplete

RRCResumeRequest/RRCResumeRequest1

RRCSetupComplete

RRCSetupRequest

ULInformationTransfer

In some implementations, in transmitting the TA report, processor 212 may transmit the TA report in a RACH procedure. In some implementations, in transmitting the TA report in the RACH procedure, processor 212 may transmit the TA report in a message 3 (Msg3), message 5 (Msg5) or message A (MsgA) in a 2-step or 4-step RACH procedure.

In some embodiments of the present disclosure, responsive to a TA value deviating from a threshold by at least a predefined amount or responsive to expiry of a timer as described above, when the UE is in Idle mode, UE may initiate a RA procedure and send TA report is sent in Msg3 or MsgA, in a MAC CE with TA report or an RRC message as described above; and when the UE is Connected mode, UE may send a MAC CE with TA report or an RRC message (Scheduling Request (SR) may be sent by the UE if it has no UL resources to transmit the MAC CE).

In some embodiments of the present disclosure, when the UE 110 is configured to always report the TA during the RA procedure, the UE may send TA report in Msg3 or MsgA, in MAC CE or RRC message.

In some embodiments of the present disclosure, when the UE is in Idle mode, UE may report its autonomously determined TA in spare bits of Msg3 during RA procedure.

Signaling from the Network to Initiate the TA Report

In some implementations, network node 125 may trigger the TA report by sending the UE MAC CE or RRC message.

In some embodiments of the present disclosure, a new MAC CE may be introduced (e.g. TA Report Request MAC CE), and may use a currently unused (reserved) LCID value. The MAC CE may not have a payload (only assigned an LCID, and the size of the MAC CE is zero bits).

In some embodiments of the present disclosure, the TA report request may be transmitted via or with a new RRC message, such as RRCTimingAdvanceReportRequest.

In some embodiments of the present disclosure, the TA report request may be transmitted in a new information element (IE) in existing RRC message(s). As an example, the new IE may be added in the following RRC messages in italic type:

For LTE/NB-IoT:

Paging/Paging-NB

RRCConnectionReconfiguration/RRCConnectionReconfiguration-NB

RRCConnectionReestablishment/RRCConnectionReestablishment-NB

RRCConnectionResume/RRCConnectionResume-NB

RRCConnectionSetup/RRCConnectionSetup-NB

For NR:

Paging

RRCReestablishment

RRCReconfiguration

RRCResume

RRCSetup

### Transmission Mechanisms for the TA Report

In some implementations, the TA report may be transmitted in Msg3 or MsgA of RA procedure (in a MAC CE or RRC message), in an RRC message after completing the RA procedure (e.g. Msg5) or in any UL MAC Protocol Data Unit (PDU) when the UE is in Connected mode (e.g. hysteresis-based or threshold-based, timer-based, periodically and procedure-based).

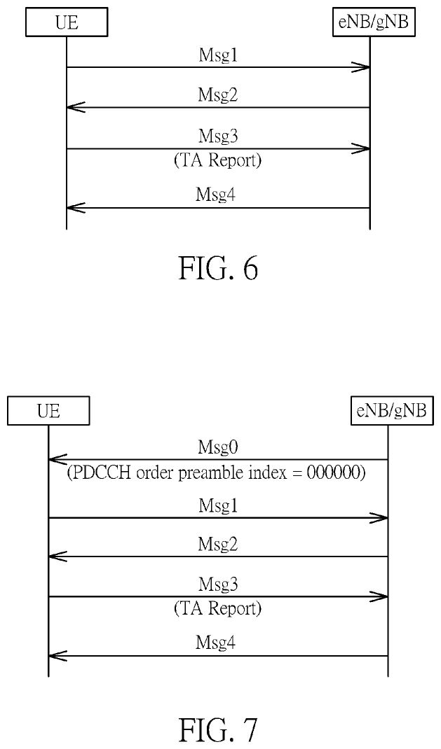

FIG. 6 illustrates an example message flow for TA Report in 4-step RACH in accordance with an implementation of the present disclosure. In this example, the UE sends TA report in Msg3.

FIG. 7 illustrates another example message flow for TA Report in 4-step RACH in accordance with an implementation of the present disclosure. In this example when network node 125 (e.g. the eNB/gNB or satellite) initiates contention based random access with PDCCH order (e.g. signaled preamble index=000000), the UE sends TA report in Msg3.

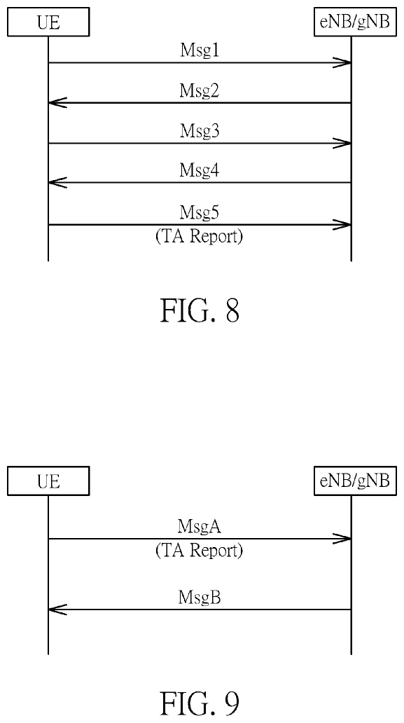

FIG. 8 illustrates yet another example message flow for TA Report in 4-step RACH in accordance with an implementation of the present disclosure. In this example, the UE sends TA report in Msg5.

FIG. 9 illustrates an example message flow for TA Report in 2-step RACH in accordance with an implementation of the present disclosure. In this example, the UE sends TA report in MsgA.

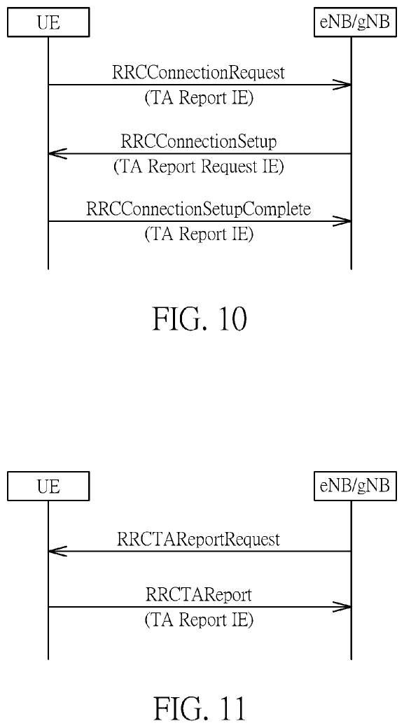

In some implementations, the TA report may be transmitted in RRC message. As mentioned above, the TA may be reported in a new IE in existing RRC message(s). FIG. 10 illustrates an example message flow for TA Report via a new IE in existing RRC message (for example, the TA Report IE in RRCConnectionRequest or in RRCConnectionSetupComplete as shown in FIG. 10) in accordance with an implementation of the present disclosure. Additionally, as mentioned above, the TA report request may be transmitted in a new IE in existing RRC message(s) (For example, the TA Report Request IE in RRCConnectionSetup as shown in FIG. 10).

Additionally, as mentioned above, the TA may be reported in a new RRC message. FIG. 11 illustrates an example message flow for TA Report via a new RRC message in accordance with an implementation of the present disclosure. TA Report may be included in a new UL RRC message (for example, the TA Report IE in RRCTAReport as shown in FIG. 11), and optionally, TA Report Request may be included in a new DL RRC message (for example, the RRCTAReportRequest as shown in FIG. 11).

In some implementations, in Connected mode, when the UE is UL synchronised and there are no UL resources available, if the TA Report is triggered (e.g. by the expiry of a timer), the UE may send a Scheduling Request to the network to request UL resources.

FIG. 12 illustrates an example message flow for TA Report when there are no UL resources available in accordance with an implementation of the present disclosure. The UE sends a Scheduling Request to the network to request UL resources and receives UL grant from the network. When UE obtains UL resources, UE sends the TA report in MAC CE in UL MAC PDU.

In some implementations, processor 212 may perform additional operations. For instance, under a proposed scheme pertaining to TA reporting by UE in NTN communications in accordance with the present disclosure, processor 212 may receive, via transceiver 216, from network apparatus 220 an apparatus-specific (e.g. UE-specific) configuration of an offset value (K_{offset}). That is, the offset value is specific to apparatus 210 and may be different for other UE(s) in wireless communication with the network. Moreover, processor 212 may perform, via transceiver 216, UL scheduling or UL transmission with the offset value applied.

In some implementations, the offset value may be initially based on a maximum RTT over a beam. In such cases, network apparatus 220 may apply the apparatus-specific configuration of the offset value based on a TA value indicated in a TA report after network apparatus 220 receives the TA report from apparatus 210.

### Illustrative Process

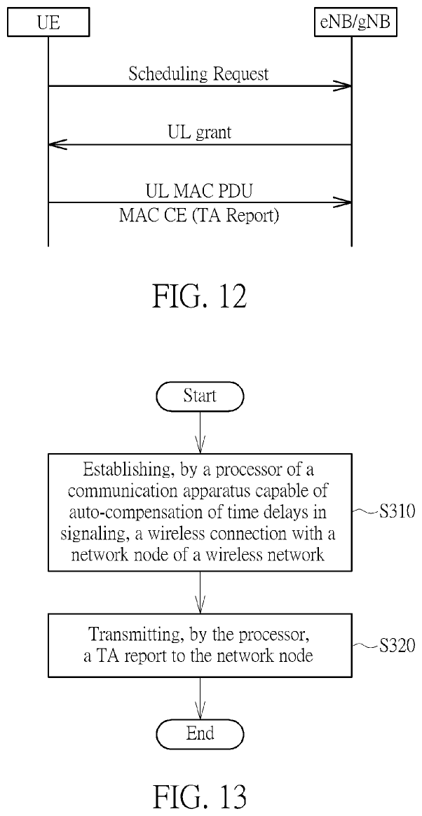

FIG. 13 illustrates an example process of a method for reporting timing advance in NTN communications in accordance with an implementation of the present disclosure. The process may be an example implementation of schemes described above, whether partially or completely, with respect to TA reporting by UE in NTN communications in accordance with the present disclosure. The process may represent an aspect of implementation of features of communication apparatus 210. The process may include one or more operations, actions, or functions as illustrated by one or more of steps 310 and 320. Although illustrated as discrete steps, various steps of the process may be divided into additional steps, combined into fewer steps, or eliminated, depending on the desired implementation. Moreover, the steps of the process may executed in the order shown in FIG. 3 or, alternatively, in a different order. The process may be implemented by communication apparatus 210 or any suitable UE or machine type devices. Solely for illustrative purposes and without limitation, the process is described below in the context of communication apparatus 210 and network apparatus 220. The process may begin at step S310.

Step S310: the processor 212 of communication apparatus 210 (which is capable of auto-compensation of time delays in signaling) may establish a wireless connection with network apparatus 220 as a network node (e.g., network node 125) of a wireless network (e.g., network 120).

Step S320: the processor 212 may transmit, via transceiver 216, a TA report to the network node, wherein a TA value is indicated in the TA report. Under a proposed scheme pertaining to TA reporting by UE in NTN communications in accordance with the present disclosure, triggering of transmitting the TA report may be initiated either at the network node or at the communication apparatus.

Detailed embodiments and implementations have been described above in the specification and thus are omitted here for brevity. Reference may be made to the above sections.

Those skilled in the art will readily observe that numerous modifications and alterations of the device and method may be made while retaining the teachings of the invention. Accordingly, the above disclosure should be construed as limited only by the metes and bounds of the appended claims.

1. A communication apparatus, comprising:
a transceiver, configured to transmit and receive wireless signals; and
a processor, coupled to the transceiver and configured to perform operations comprising:
establishing, via the transceiver, a wireless connection with a network node of a non-terrestrial network (NTN); and
transmitting, via the transceiver, a timing advance (TA) report to the network node,
wherein the processor is configured to perform auto-compensation of time delays in signaling and a TA value is indicated in the TA report.

2. The communication apparatus of claim 1, wherein the processor is configured to perform the operation of transmitting the TA report responsive to a PDCCH order signaling received from the network node.

3. The communication apparatus of claim 1, wherein the processor is configured to perform the operation of transmitting the TA report responsive to a paging message received from the network node.

4. The communication apparatus of claim 1, wherein the processor is configured to perform the operation of transmitting the TA report responsive to a TA report request received from the network node.

5. The communication apparatus of claim 4, wherein the TA report request is transmitted in a medium access control (MAC) control element (CE).

6. The communication apparatus of claim 4, wherein the TA report request is transmitted via a radio resource control (RRC) signaling.

7. The communication apparatus of claim 1, wherein the processor is configured to perform the operation of transmitting the TA report responsive to the TA value deviating from a threshold by at least a predefined amount or responsive to expiry of a timer.

8. The communication apparatus of claim 1, wherein the processor is configured to perform the operation of transmitting the TA report autonomously in a predetermined procedure.

9. The communication apparatus of claim 1, wherein, in transmitting the TA report, the processor is configured to perform one or more of:
transmitting the TA report in a medium access control (MAC) control element (CE); and
transmitting the TA report via radio resource control (RRC) signaling.

10. The communication apparatus of claim 1, wherein, in transmitting the TA report, the processor is configured to transmit the TA report in a random access channel (RACH) procedure, wherein, in transmitting the TA report in the RACH procedure, the processor is configured to transmit the TA report in message 3 (Msg3), message 5 (Msg5) or message A (MsgA) in a 2-step or 4-step RACH procedure.

11. A method for reporting timing advance (TA), comprising:
establishing, by a processor of a communication apparatus capable of auto-compensation of time delays in signaling, a wireless connection with a network node of a wireless network; and
transmitting, by the processor, a TA report to the network node,
wherein a TA value is indicated in the TA report, and triggering of transmitting the TA report is initiated either at the network node or at the communication apparatus.

12. The method of claim 11, wherein the triggering of transmitting the TA report is initiated at the network node, and the transmitting of the TA report comprises transmitting the TA report responsive to a PDCCH order signaling received from the network node.

13. The method of claim 11, wherein the triggering of transmitting the TA report is initiated at the network node, and the transmitting of the TA report comprises transmitting the TA report responsive to a paging message received from the network node.

14. The method of claim 11, wherein the triggering of transmitting the TA report is initiated at the network node, and the transmitting of the TA report comprises transmitting the TA report responsive to a TA report request received from the network node.

15. The method of claim 14, wherein the TA report request is transmitted in a medium access control (MAC) control element (CE).

16. The method of claim 14, wherein the TA report request is transmitted via a radio resource control (RRC) signaling.

17. The method of claim 11, wherein the triggering of transmitting the TA report is initiated at the communication apparatus, and the transmitting of the TA report comprises transmitting the TA report responsive to the TA value deviating from a threshold by at least a predefined amount or responsive to expiry of a time.

18. The method of claim 11, wherein the transmitting of the TA report comprises transmitting the TA report in a medium access control (MAC) control element (CE).

19. The method of claim 11, wherein the transmitting of the TA report comprises transmitting the TA report via radio resource control (RRC) signaling.

20. The method of claim 11, wherein the transmitting of the TA report comprises transmitting the TA report in message 3 (Msg3), message 5 (Msg5) or message A (MsgA) in a 2-step or 4-step random access channel (RACH) procedure.
